(19) United States
(12) Patent Application Publication
(10) Pub. No.: US 2014/0379370 A1
(43) Pub. Date: Dec. 25, 2014

(54) INTERACTIVE SYSTEM FOR TRACKING A SERIES OF ORDERED STEPS

(71) Applicant: SOVINTY, AUSSONNE (FR)

(72) Inventor: Francois Prigent, Aussonne (FR)

(21) Appl. No.: 14/371,759

(22) PCT Filed: Jan. 14, 2013
(86) PCT No.: PCT/EP2013/050595

§ 371 Date: Jul. 11, 2014

(30) Foreign Application Priority Data
Jan. 13, 2012 (FR) 12 50365

(51) Int. Cl. G06F 19/00; G06F 17/30; H04L 29/08

(52) U.S. Cl. CPC G06F 19/327; H04L 67/10; G06F 17/30312
USPC 705/2

(57) ABSTRACT

A system for making safe the conduct of a succession of ordered steps. The succession of steps being applied to transform it to a mobile physical entity. The system comprises a database for inputting and storing the succession of steps, at least one step being associated with at least one prior step. An identification device identifies the physical entity in a zone of conduct of a step in progress. A terminal displays the successive steps. A server verifies that each prior step associated with the step in progress has been previously validated and manages discharge of the physical entity from the zone of the conduct of the step in progress. A sensor validates the realization of the step in progress by an operator associated with the step in progress. A storage device stores each validation.

The invention pertains to the field of systems for managing data. It is aimed more particularly at an interactive system (device and method) for making safe the correct conduct of a succession of ordered steps during the transformation of a physical object.

### DISCLOSURE OF THE INVENTION

The invention is aimed firstly at a system for making safe the conduct of a succession of ordered elementary operations, said succession of elementary operations being applied so as to transform it to a mobile physical entity. The system comprises:
means of input and storage of the succession of elementary operations, at least one elementary operation being associated with at least one other elementary operation, termed a prior elementary operation,
means of identification of the physical entity in a zone of conduct of an elementary operation, termed an elementary operation in progress,
means of successive display of said elementary operations,
means of authorization of conduct of an elementary operation associated with a previously validated elementary operation,
a sensor of validation of the elementary operation in progress, by an operator associated with said elementary operation,
means of storage of each validation.

It comprises, in a particular case of implementation, means of discharge of the physical entity from the zone of conduct of the elementary operation in progress.

Stated otherwise, the means of authorization of conduct of an elementary operation associated with a previously validated elementary operation are means for verifying that each prior elementary operation associated with the elementary operation in progress has been previously validated.

By way of example, in the particular case of a hospital procedure decomposed into a series of elementary operations (entry of the patient, analyses, consultation, surgery etc.), the physical entity is a patient, the operators are surgeons, doctors, nurses or other care staff, the elementary operations are for example those of a surgical intervention, including pre- and postoperative operations, and the zone of conduct is a surgical unit, or a care ward.

In a particular embodiment, the means of identification of the physical entity comprise a wristband comprising a remotely-read identification code. Such an identification code can be of bar code, QR Code, RFID type etc.

In a particular embodiment, for at least one elementary operation, the validation of said elementary operation comprises several levels according to a grading of the conduct of the elementary operation, and the means of authorization of conduct of an elementary operation associated with a prior elementary operation deliver an authorization of conduct when the level of validation of the prior elementary operation satisfies a predetermined criterion.

More particularly in this case, the means of successive display of the elementary operations comprise color patterns associated with the levels of validation of at least one procedure prior to the elementary operation in progress, said patterns and colors being chosen so as to particularly attract the attention of an operator regarding critical parameters of the elementary operation in progress or regarding prior elementary operations associated with validation levels below a predetermined threshold.

In a particular embodiment, the sensor for validating the elementary operation in progress comprises means for verifying the identity of the operator performing the validation. Such an identity verification means may in particular be an electronic signature, a wristband with bar code, or a voice signature.

In a particular embodiment, the means for storing each validation comprise a storing of the date and of the identity of the operator responsible for said validation.

More particularly in this case, the system comprises means for encrypting the stored validation data, so as to render these data unmodifiable after validation.

The system makes it possible to effectively reduce the human error factor and medical errors by virtue of two fundamental principles: continuous verification of a patient's unique identifier and specifications of an associated medical procedure (a set of elementary operations), and the establishment and the historical tracking, signed in an unalterable manner, of an electronic check list for each elementary operation, which guarantee that each elementary operation of a procedure is performed according to the standards.

Still in this case, in a particular embodiment, the system comprises means of calculating a time between two validations of successive elementary operations, and of comparing this time with a previously stored value.

Such a system then makes it possible to verify the consistency of interlude between two elementary operations with minimum or mean values. In the case where the complete procedure involves a minimum time between two elementary operations (injection of a particular product at least 24 hours before the start of an operation), a duration of less than this minimum duration between the validations of the two elementary operations does not necessarily entail the blocking of the medical procedure, but causes the emission of an alert, for example visual, to an operator of the following elementary operation.

In a particular embodiment, at least certain elementary operations or complete procedures (sets of elementary operations) are associated with check lists of parameters, and the system comprises means of downloading pre-existing check lists.

The system makes it possible to load check lists inspired either on the basis of the safety check lists of the OMS, or be it or on the basis of other recognized medical institutions. This system can be extended to other fields of medicine, such as radiotherapy, by modifying various lists in the software.

Information screens, relating to the check list and the patient, are displayed in the operating room when such a room is made necessary by the patient's medical procedure, to provide the medical team with a dynamic tool for ensuring that all the safety measures are applied during said procedure.

The system is dynamic and displays alerts when error factors are liable to occur. In the case where a medical error occurs, the historical record of the check list (list of validations of already validated elementary operations) allows the medical team to show that the correct procedure was complied with for avoiding this error, or if it occurs, which measures were omitted.

The invention is aimed under a second aspect at a method for making safe the conduct of a succession of ordered elementary operations, said succession of elementary operations being applied so as to transform it to a mobile physical entity, characterized in that the method comprises steps of:
input and storage of the succession of elementary operations, at least one elementary operation being associated with at least one other elementary operation, termed a prior elementary operation,
identification of the physical entity in a zone of conduct of an elementary operation, termed an elementary operation in progress,
successive display of said elementary operations,
verification that each prior elementary operation associated with the elementary operation in progress has been previously validated,
validation of realization of the elementary operation in progress, by an operator associated with the elementary operation in progress,
storage of each validation,
storage of movements of the physical entity.

The invention is further aimed at a hospital, comprising a system such as disclosed.

In another example, in the case of a procedure for transforming chemical products, the physical entity is a chemical product batch undergoing processing, the operators are staff assigned to the tracking of the transformations applied to the batch of chemical products, and the elementary operations are those of a production of a chemical compound on the basis of another compound.

### PRESENTATION OF THE FIGURES

FIG. 1 is a diagram of the main elements involved in the method,

FIG. 2 is a flowchart of the main steps of the method of operation and patient tracking,

FIG. 3 is a schematic representation of the system and of the modification of the multiuser data in real time,

FIG. 4 is a flowchart of the steps of the analysis of the wristband,

FIG. 5 illustrates the structure and the display of the check-lists,

FIG. 6 is a flowchart of the steps of the response to the list.

### DESCRIPTION OF A PARTICULAR EMBODIMENT OF THE INVENTION

The description which follows presents a wholly non-limiting example of implementing the system for tracking a succession of ordered elementary operations. These elementary operations form a tree structure in which a given elementary operation can lead on to several following elementary operations, according to parameters specific to said elementary operation.

In this example, the system allows the tracking, within a care establishment (hospital in the present case), of a patient having to undergo one or more medical procedures or operations which must be carried out while complying with a precise ordering and optionally a specific interlude between two medical procedures. Each of these elementary operations involves at least one operator (nurse, doctor, surgeon etc.).

It is noted here that, in another implementation, tailored to the case of a procedure for transforming materials or objects, the system allows the tracking of an object or of a batch of materials (which then replaces the “patient” of the procedure applied to the hospital setting) having to undergo one or more elementary operations or transformations which must be carried out while complying with a precise ordering and optionally a specific interlude between two elementary operations. Each of these elementary operations involves at least one operator.

The system is intended to be implemented in both software and hardware form.

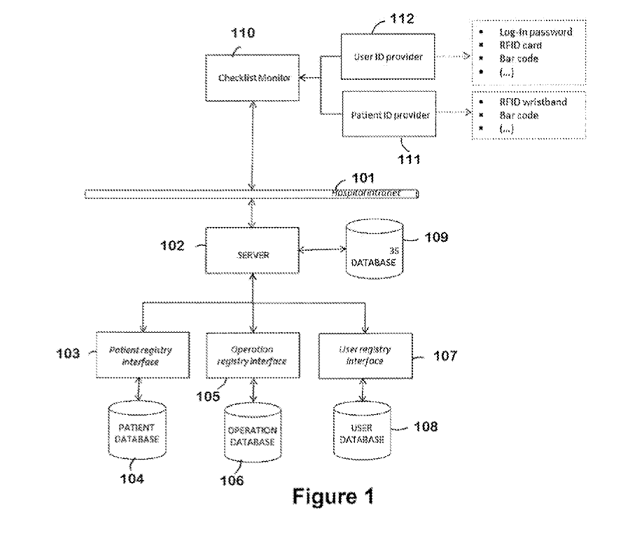

Its software part is interfaced with an internal network 101 (here of intranet type) of the hospital in which the system is installed (see FIG. 1). It is executed within at least one server 102 linked to this internal network 101. This server 102 affords in particular access, by way of terminals of conventional PC type, not detailed further here, to:
a patient management interface 103, linked to a patient database 104,
an elementary operation management interface 105, linked to a database of elementary operations and procedures 106,
an operator management interface 107, linked to a database of operators 108.

The server 102 is also linked to a database 109 comprising the elements necessary for the implementation of the software (interfaces, parameters, storage of dates of validation and of operators associated with a patient and a set of elementary operations etc.).

Likewise, the internal network 101 of the hospital is accessible through diverse terminals 110 allowing the display and the tracking of a check-list associated with an elementary operation and with a patient, as well as the identification of the patient 111 and the identification of the operator 112. The display terminal 110 can here be a computer, tablet, or any other electronic display which allows:
Connection to the server 102 (Wi-Fi, Ethernet, etc.)
Correct and practical display of the screens of the software.

The system comprises:
means of input and storage 109 of a succession of elementary operations, at least one elementary operation being associated with at least one other elementary operation, termed a prior elementary operation,
means of identification 111 of the physical entity in a zone of conduct of an elementary operation, termed an elementary operation in progress,
means of successive display 110 of said elementary operations,
means of authorization 102 of conduct of an elementary operation associated with a previously validated elementary operation,
a sensor of validation 112 of the elementary operation in progress, by an operator associated with said elementary operation,
means of storage 106 of each validation.

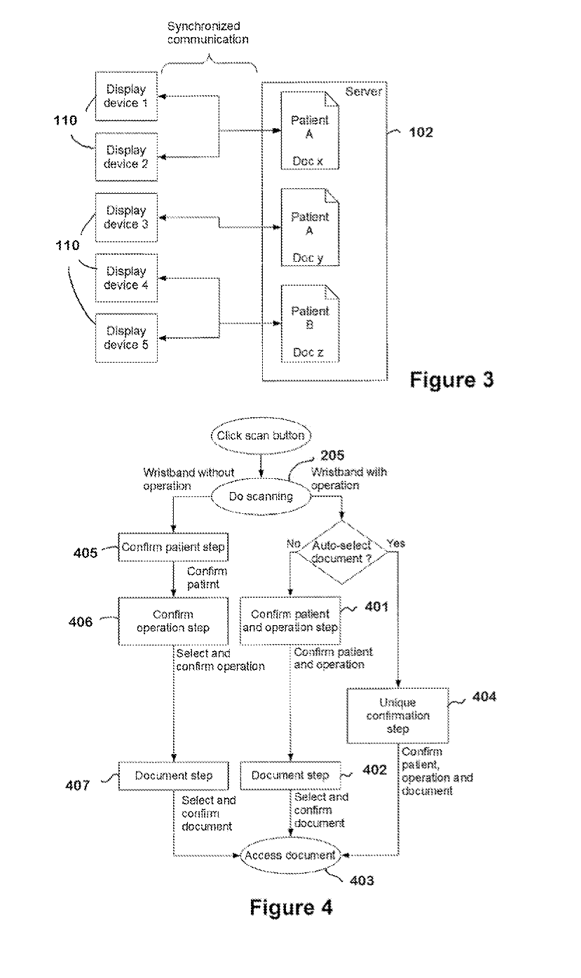

As illustrated in FIG. 3, the system allows several members of the medical team to use different display devices 110 to access and modify a document relating to one and the same patient (check-list, for example).

Stated otherwise, the system can be used at several locations in the hospital at the same time, for one and the same patient. An item of data modified from one display device 110 is transferred to the server 102 via the hospital's internal network 101, is stored in the databases associated with the server 102, and is therefore automatically updated on the other display devices 110 which access another document relating to the same patient.

Documents relating to several patients can be consulted and modified on the same server 102 from numerous display devices 110, according to the same principle.

An off-line mode is also available to allow the software for displaying and tracking a check-list associated with a procedure and a patient to function effectively in case of a temporary problem of communication with the server 102.

The same holds in the case of use of a device 110 temporarily non-connected to the internal network 101, and which synchronizes with the server 102 at certain times.

Generally, in the present method applied to the case of a medical intervention, there exists a notion of folder/patient, which folder contains various documents relating to the same patient. The software implementing the method makes it possible to manage the patient's complete progression, from their 1st consultation up to their discharge.

During the consultation, a “surgical consultation” document is added to the folder and filled in by the surgeon.

At the end of the consultation, several possibilities are offered to the practitioner:
he prescribes complementary examinations,
he schedules an operation directly,
or he decides that there is no reason to operate on this patient.

Each request for additional examinations can form the subject of a creation of an elementary operation which contains its own check-lists (e.g.: radiography).

When the surgeon decides that the patient will be operated on (either directly at the end of the consultation, or after the examinations), an “operation process” is then created, a folder being associated with this operation.

This “operation process” comprises various elementary operations which each form the subject of a validation document, in particular:
preoperative meeting of the staff
check-up visit from the anesthetist, on the eve of the operation
referral chart (which contains the preparation of the patient in the department before departure to the unit)
operative unit check-list
recovery room chart

For these various elementary operations, and in particular for the check-list of the unit, a document tailored to the specifics of the operation is chosen. Any document can be interrupted and a new one chosen if the situation so requires.

It is useful here to note the specificness of the consultation which exists independently of an operation, that is to say that there is a making-safe procedure which exists independently of the series of elementary operations to be made safe. This making-safe procedure makes it possible to choose the various series of elementary operations to be implemented in respect of the physical object.

Moreover, in the course of a series of elementary operations (procedure), the result of the verificatory checks performed may modify the subsequent procedure, either by interrupting it, or by adding an intercalary process, or by performing reversals in the procedure, etc. The determination of the path to be followed, within the tree of possible series of elementary operations, is therefore done in tandem with the state and with the result. It is therefore possible to traverse the tree of elementary operations or to modify it.

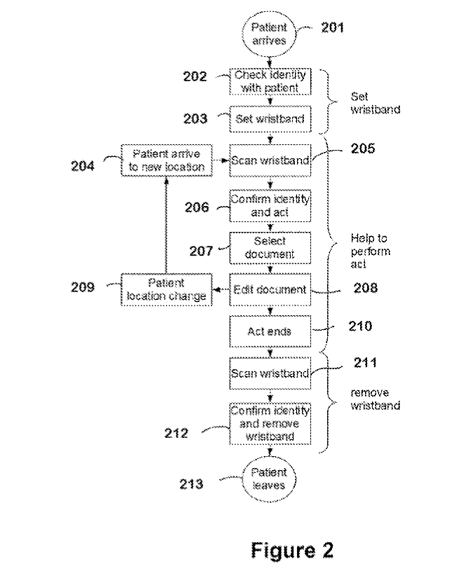

As seen in FIG. 2, the steps of the patient tracking method are as follows, in the present nonlimiting exemplary implementation:

In a first step 201, the patient arrives within the care establishment.

A step 202 then consists in making sure of the absence of any risk of error in the identity of the patient and the medical procedure envisaged (“intervention” in the subsequent description). Accordingly, a patient identification check list must be completed and a medical procedure to be applied (formed of a set of elementary operations ordered as a tree) must be associated therewith.

Once the operator has completed the patient identification check list, he can associate a unique means of identification with the patient. In an exemplary embodiment, this is a wristband comprising a remotely-read identification code. Such an identification code can be of bar code, QR Code, RFID type etc.

The wristband is generally associated with a patient and a procedure to be applied to him. Two cases can occur:
The procedure to be carried out on the patient is not yet known, and will be associated with the wristband later. Stated otherwise, only the identification of the patient is associated with the wristband initially, but the wristband can be updated subsequently with a procedure.
The procedure is known and associated with the wristband within the same screen as the association of the patients.

If a wristband does not have any associated procedure (intervention), the check-list screen 110 is naturally not accessible to the operators.

The documents (check-list) related to an intervention are created solely when an intervention is defined and associated with a wristband.

The method described here allows the health establishment the choice of wristband technology, and can in particular work with barcode and RFID wristband. After having associated the wristband with the patient's information, the user or the member of the medical team can physically attach the wristband onto the arm of the patient (step 203).

The wristband is then ready to be used to identify the patient for the surgical intervention and allow the medical team to respond to the safety check-list through the interface of the software.

When the patient is transferred to a new place to follow a procedure (step 204) therein, his wristband is interrogated (step 205), for example read by a bar code optical reading device, to confirm the patient's identity and the nature of the procedure to be applied to him (step 206).

In the present implementation, the identification wristband must be scanned to access a document (typically check-list) relating to a patient and an associated operation (see FIG. 4 which details steps 205 and 206).

In the general case, when the wristband is associated with a patient and an intervention, the operator confirms that the identity of the patient is correct and that the intervention to be performed is the appropriate one (step 401), and it is then possible for him to select the documents (step 402) so as to view them and complete them during the intervention (step 403).

In a variant embodiment, for improved convenience of use, the software can be configured to automatically select (step 404) the necessary documents (for example, always select the surgery list in the operating room).

In the case where the wristband is associated with a patient but is not associated with an intervention, in a step 405, the operator verifies the identity of the patient, and then in a step 406 the intervention to be performed on this patient, and finally, he accesses the step of selecting the document to be displayed (step 407).

In a step 207, the system displays the operator interface or interfaces (for example preoperative check-list) allowing correct carrying out of the elementary operations involved in the procedure applied to the patient.

The carrying out of the operations is validated, by one or more operators, in a step 208.

Next, in a step 209, the patient is optionally transferred to a new place (recovery room etc.).

When the care operations have terminated (step 210), the wristband is again interrogated in a step 211, so as to obtain a new confirmation of identity (step 212) before removal of the wristband and departure of the patient (step 213).

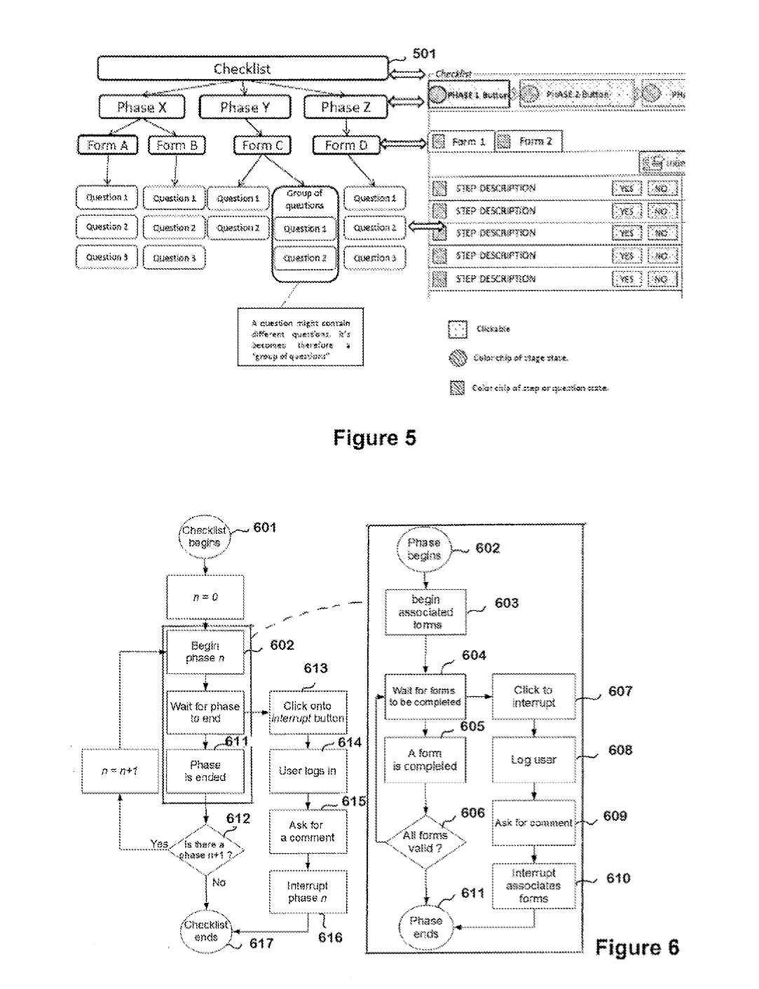

The subsequent description details steps 207 and 208. As seen in FIG. 5, a check-list 501 associated with an operative procedure is subdivided into phases X, Y, Z. A phase is defined as an object associated with several operator forms (visual interfaces) containing data. A phase is related to a particular step of the operative procedure followed by the patient.

In the present exemplary system organized around surgery check-list tracking, the procedure can be decomposed into five phases as follows:
f preoperative
f before anesthesia
f before surgical intervention
f after the operation
f postoperative room, or recovery room

Each of these phases X, Y, Z involves the displaying of forms denoted Form A, Form B, Form C, Form D in FIG. 5. An operator form is an interface comprising a set of related questions.

Each response to a question of a form (the response to this question naturally being associated with a particular patient and a particular operation) is characterized by a state which is updated upon a response to said question. On the operator interface, a group of color patterns advises as to the current state of the question.

This state principle is also used with the principle of phase of the operation, each state of a phase providing an aggregated item of information regarding the state of the questions included in this phase, according to predefined aggregation rules. By way of example, the aggregation of a WARNING state and of a results OK state produces a WARNING state. Likewise, the aggregation of a WARNING state, of an OK state and of an error state results in an error state.

In the present implementation, the check-list system uses six different states: “Off”, “In Progress”, “Ok”, “Attention”, “Error”, and “No response”. The “Off” state can lead to the “in progress” state. The “in progress” state can culminate in the other four states “Ok” (correct response indicating conventional conduct of procedure), “Attention” (response indicating a non-conventional procedure or a particular case which could culminate in an increased risk of procedure error), “Error” (high risk of error during the procedure), and “No response”.

FIG. 6 details the tracking of a check-list (step 208 of FIG. 2).

Initially (step 601), the check-list is started. A first phase is launched in a step 602, and an associated form is displayed on the operator terminal 110 in a step 603. A loop 604-605-606 for completing the form is then traversed. In case of interruption by an operator (step 607), the software requests an operator identifier (step 608) and an interruption comment (step 609) and interrupts the associated form (step 610).

Next the phase is terminated (step 611).

Likewise, a loop 602-611-612 for completing the phases is traversed.

Here again, in case of interruption by an operator (step 613), the software requests an operator identifier (step 614) and an interruption comment (step 615) and interrupts the associated phase (step 616).

At the end of the completion of the phases, the check-list is terminated (step 617).

An edit screen allows the operator to respond to the various questions of the check-list during use.

A summary screen displays questions for which the responses could involve a higher risk of medical errors (errors having a large impact on the quality of the result of the procedure). In an implementation variant, a weighting system is applied to each of the questions, and allows a ranking of the questions in order of importance. Consequently, crucial questions which have received a suspicious response are highlighted and quickly noted by the operator.

A paper type screen displays the check-list in accordance with the official paper version of this list if it exists. This screen provides the medical team with easier reading of the check-list.

The data validation modes comprise a case of prior identification of the operator, and a case of a posteriori identification of the operator.

In the present exemplary implementation, six types of questions are implemented in the check-list:
single-choice question. The response to such a question is obtained by clicking on one of a series of response buttons. These are generally “Yes”, “No”, and “N/A”. In certain cases, for this type of question, an additional comment of the operator is necessary, which may be made compulsory. Access to the confirmation button is refused as long as the comment is not entered.
signatory verification question. This type of question seeks an electronic signature from the user.
information question. This type of question allows the user to input an item of information and to link it to the element. The items of information input are displayed under the title of the question.
multi-information question. This type of question allows the user to add a certain quantity of information elements (with a minimum and a maximum of information elements).
cross-check question. This kind of question means that all the operators involved in the phase respond to the same question and sign their response. If the responses given by the various operators are different, a pop-up warning will appear and will display the various responses, the question will be reinitialized and the users will have to respond to the question again.
linked questions. This specific question is composed of two questions posed at various times in the procedure. If the second response does not correspond to the first, a warning window is displayed and requests the user to select: keep his response (which differs from the previous one) or replace his response with the previous response.

In a second type of linked questions, the response given during the 1st question is displayed by way of indication during the 2nd question. If the responses differ, there is no particular action except for the presentation of the item of information. Questions of this type correspond to typical cases where agreement is not indispensable.

Once the response to a question has been entered, the question is linked with a signature and its response. A state is also associated with a question so as to inform regarding its state (in particular responded or not) or the response.

It should be noted, in regard to the confirmation safety system that the response to a question is subjected to two safety systems: the identification of the operator, and then a confirmation button which appears on the operator interface 110 for each intentional modification. The modification of a response to a question therefore involves at least two consents of the operator.

Each time that a sub-window displayed in the foreground of the operator interface (window of “popup” type) appears on the operator interface 110, with the aim of attracting the user's attention to the contextual window, shading is displayed on the main window. Furthermore, this shading precludes clicking on the main window; only the contextual box is available. This shading disappears when the sub-window is closed.

Likewise, when the operator responds to a question, a confirmation box appears against the question, plus other elements. Light shading appears on all the windows, except on the question and the confirmation box.

The shading makes it possible to concentrate on the question and prevents clicking on any other questions or on buttons of the interface. This shading disappears when the user confirms or cancels his response.

### Advantages

The present system exhibits several advantages:

Traceability of the elementary operations making up a procedure

Nowadays, any industry requires traceability of the various elementary operations of its procedures, which must translate into accountability of the operators involved. The system such as disclosed makes it possible to preserve a trace of the elementary operations of a procedure and of their author, by virtue of computerized check-lists and electronic signature management.

### Protocols and Updates of Knowledge

Beyond a simple electronic check-list intended to accompany in the execution of a procedure, the system comprises a didactic function, and affords contextualized access to the protocols when they are necessary, guaranteeing the appropriate conduct of an elementary operation in case of oversight. These lists of protocols can be updated and instantaneously transmitted to all the users of the system.

### Making Safe and Improvement of Communications

Alerts appear if the data introduced indicate a risk of error, and a color code system allows fast evaluation of the state of a situation. Moreover, an integrated messaging system makes it possible to dispatch a comment subsequently, which will be distributed at the appropriate time, to the appropriate person (operator in charge of the elementary operation in progress).

### Archiving and Statistical Analysis of Reports

All the check-lists and other recorded data are archived in secure databases and make it possible to prove the appropriate conduct of the prior elementary operations. Moreover, the extraction of these data for statistical purposes transforms the system disclosed into a decision aid tool for improving the procedures and the productivity of the user.

### Ergonomics

The intuitive interfaces (color codes, blocking of the main windows when a sub-window is displayed etc.) allow very fast familiarization with the system. Moreover, the ergonomics has been devised so as to decrease any risk of confusion and of error on the part of the users.

1-11. (canceled)

12. A system for making safe a conduct of a succession of ordered elementary operations, said succession of elementary operations being applied to transform it to a mobile physical entity, the system comprising:
a database for inputting and storing the succession of elementary operations, at least one elementary operation being associated with at least one prior elementary operation;
an identification device for identifying the physical entity in a zone of conduct of an elementary operation in progress;
a terminal for successive displaying of the elementary operations;
a server for authorizing a conduct of an elementary operation associated with a previously validated elementary operation;
a sensor for validating the elementary operation in progress, by an operator associated with said elementary operation; and
a storage device for storing each validation.

13. The system as claimed in claim 12, wherein the identification device for identifying the physical entity comprises a wristband comprising a remotely-read identification code.

14. The system as claimed in claim 12, wherein, for at least one elementary operation, validation of the elementary operation comprises a plurality of levels according to a grading of the conduct of the elementary operation; and wherein the server delivers an authorization of conduct when the level of validation of the prior elementary operation satisfies a predetermined criterion.

15. The system as claimed in claim 14, wherein the terminal displays the elementary operations in color patterns associated with the levels of validation of at least one procedure prior to the elementary operation in progress, said patterns and colors being chosen to attract attention of the operator regarding critical parameters of the elementary operation in progress or regarding at least one prior elementary operation associated with validation level below a predetermined threshold.

16. The system as claimed in claim 12, wherein the sensor for validating the elementary operation in progress verifies an identity of the operator performing the validation.

17. The system as claimed in claim 12, wherein the storage device for each validation stores a date and an identity of the operator responsible for said each validation.

18. The system as claimed in claim 17, wherein the server encrypts the system stored validation data to render the stored validation data unmodifiable after validation.

19. The system as claimed in claim 17, wherein the server calculates a time between two validations of successive elementary operations, and compares the time with a previously stored value.

20. The system as claimed in claim 12, wherein the server downloads check lists of parameters and elementary operations, the check lists being established by external organizations; and wherein a subset of the elementary operations are associated with the check lists.

21. A method for making safe a conduct of a succession of ordered elementary operations, said succession of elementary operations being applied so as to transform it to a mobile physical entity, further comprising the steps of:
inputting and storing the succession of elementary operations in a database, at least one elementary operation being associated with at least one prior elementary operation;
identifying the physical entity in a zone of conduct of an elementary operation in progress;
successive displaying of the elementary operations on a terminal;
verifying that each prior elementary operation associated with the elementary operation in progress has been previously validated by a server;
validating a realization of the elementary operation in progress, by an operator associated with the elementary operation in progress,
storing each validation in a storage device; and
storing movements of the physical entity in the storage device.

22. The system of claim 1 for use in a hospital.
